(19) United States
(12) Patent Application Publication
(10) Pub. No.: US 2024/0193001 A1
(43) Pub. Date: Jun. 13, 2024

(54) SYSTEM FOR MANAGING HARDWARE CONTAINERIZATION FRAMEWORK

(71) Applicant: Saankhya Labs Private Limited, Bengaluru (IN)

(72) Inventors: Parag Balwant Naik, Bengaluru (IN); Anindya Saha, Bengaluru (IN); Makarand Kulkarni, Bengaluru (IN); Susmit Kumar Datta, Bengaluru (IN); Sebastian Gracias, Bengaluru (IN); Pramit Biswas, Bengaluru (IN)

(21) Appl. No.: 18/527,414

(22) Filed: Dec. 4, 2023

(30) Foreign Application Priority Data
Dec. 8, 2022 (IN) 202241070789

(51) Int. Cl. G06F 9/50

(52) U.S. Cl. CPC G06F 9/5061

(57) ABSTRACT

System and method for managing hardware containerization in a wireless network architecture, are described. In one aspect, capability information of a plurality of hardware units is transmitted to a host processor to select a set of hardware units in a system-on-chip (SoC). Configuration information that includes the selection of one or more hardware allocation parameters and one or more types of statistics for one or more processing flows is received by the selected set of hardware units. A hardware container is configured to enable SoC resource allocation related to a control group and a namespace of SoC resources via a plurality of hardware modules in the SoC. The hardware container is managed based on periodic collection and analysis of the statistical data via a plurality of instrumentation modules in the SoC, and the impact on the one or more processing flows is tracked at the host processor.

### CROSS-REFERENCE

This application claims priority to an Indian Patent Application No. 202241070789 filed on Dec. 8, 2022, and the entire content disclosed by the Indian patent application is incorporated herein by reference as part of the present application for all purposes under U.S. law.

### FIELD

Various embodiments of the disclosure relate to the wireless network architecture systems. More specifically, various embodiments of the disclosure relate to a system and method for managing a hardware containerization framework in a wireless network architecture.

### BACKGROUND

With the continuous evolution of technological processes and the dramatic shrinkage of integrated circuits over the years, Moore's Law is entering a bottleneck. Currently, multi-core system-on-chips (SoCs) are gaining considerable attention in which pools of heterogeneous central processing unit (CPU) cores are implemented on the same die or chip. Application software stitches the flow of operations using such heterogeneous cores to implement a specific functionality. Because of the application-specific architecture for each heterogeneous core, significant gains in the traditional power, performance, area (PPA) metric may be achieved to benchmark an SoC implementation.

Additionally, such heterogenous multi-core processors may manifest a multiplicity of types of cores and cardinality of each type, lending to utilization in cloud infrastructure. The capability of the SoC may be shared by several applications, such as virtual machines, containers, and the like, in such cloud infrastructure by creating a subset of cores of distinct types from a pool of core elements. Such core elements may be viewed as computer resources partitioned between the applications.

Typically, such containers are manifested as process containers limited to resources, such as memory and generic control central processing unit computing, which an operating system can schedule to reliably provide Compute as a Service (CaaS). However, there is a desired Resource as a Service (RaaS) that may provision, meter, and isolate non-CPU like processing elements in a hardware containerization framework for ensuring Quality of Service (QOS) guarantees to containerized software workloads in a real-time environment.

The limitations and disadvantages of conventional and traditional approaches will become apparent to one of skill in the art, through a comparison of described systems with some aspects of the present disclosure, as set forth in the remainder of the present application and with reference to the drawings.

### SUMMARY

A system and a method for managing a hardware containerization framework in a wireless network architecture, are described. The system may include a memory for storing instructions and a processor in a first hardware unit configured to execute the instructions. Based on the executed instructions, the processor may further execute operations to transmit capability information to the host processor in a System on Chip (SoC). The capability information from one or more second hardware units may be received by the host processor. The capability information of each hardware unit may include a list of controllable hardware allocation parameters and a list of types of statistics and parameters associated with a collection of statistical data. A set of hardware units that may include the first hardware unit may be selected from multiple hardware units by the host processor based on the capability information. The multiple hardware units may include the first hardware unit and the one or more second hardware units.

In an embodiment, the processor may execute operations to receive configuration information that includes a selection of one or more hardware allocation parameters and one or more types of statistics for one or more processing flows from the host processor. Based on the received configuration information, the processor may further execute operations to configure a hardware container and enable SoC resource allocation related to a control group and a namespace of SoC resources via a plurality of hardware modules in the SoC. The processor may further execute operations to manage the hardware container based on periodic collection and analysis of the statistical data via multiple instrumentation modules in the SoC. Based on the periodic collection and analysis of the statistical data by the selected set of hardware units at run-time, the host processor may track the impact on the one or more processing flows.

These and other features and advantages of the present disclosure may be appreciated by a review of the following detailed description of the present disclosure, along with the accompanying figures in which reference numerals refer to like parts throughout.

### BRIEF DESCRIPTION OF THE DRAWINGS

FIG. 1 is a block diagram showing a resource management system to implement components for managing a hardware containerization framework in a wireless network architecture, according to an exemplary embodiment.

FIG. 2A shows an exemplary host computing device for managing a hardware containerization framework in a wireless network architecture, according to an exemplary embodiment.

FIG. 2B shows various components of a SoC resource, according to an exemplary embodiment.

FIG. 3 shows a block diagram of an exemplary heterogenous multi-core host processor for managing a hardware containerization framework in a wireless network architecture, according to an exemplary embodiment.

FIG. 4 shows a cloud infrastructure for managing a hardware containerization framework in a wireless network architecture, according to an exemplary embodiment.

FIG. 5 shows a block diagram of hardware architecture and resource allocation and statistical data collection schema of a hardware unit in the SoC, according to an exemplary embodiment.

FIG. 6 shows a sequence diagram depicting a sequence of operational steps corresponding to various SoC components for managing a hardware containerization framework in a wireless network architecture, according to exemplary an embodiment.

FIGS. 7A and 7B show flowcharts that collectively depict a method that includes operational steps for managing a hardware containerization framework in a wireless network architecture, according to an exemplary embodiment.

FIG. 8 shows an exemplary hardware configuration of a computing device that may implement system components for managing a hardware containerization framework in a wireless network architecture, according to an exemplary embodiment.

### DETAILED DESCRIPTION

Various embodiments of the disclosure relate to a system and method for managing a hardware containerization framework in a wireless network architecture. The objective of the disclosed system and method may enable an implementation of hardware and software on an SoC to capture performance and resource usage data using specialized instrumentation modules. Further, limits on time and amount of hardware resources consumed by a single application may also be imposed to implement a hardware containerization framework. Such a hardware containerization framework may be configured or customized to be used across different devices from different vendors. Accordingly, in certain scenarios, the system and method described may be agnostic to specific statistic types (e.g., defined by the vendors) and specific types of resources (e.g., supported by the vendor and design-specific instrumentation schemes). In other scenarios, the system and method described may mask the exact statistical information or data the instrumentation and hardware modules exhibited.

In an embodiment, traditionally managing process containers or control groups is limited to resources, such as memory and generic control central processing unit (CPU) computing elements, which may be scheduled by an operating system. The system and method described may extend the mechanism of provisioning and metering non-CPU processing elements (PEs). Like an application software, the system and method described may virtualize or containerize custom workloads, such as Artificial Intelligence (AI), graphic processing units (GPUs), radio access networks (RAN), and others, to leverage the benefits that regular software containers provide for soft implementations. Such custom workloads may define novel resources like “RAN Compute.”

Accordingly, the system and method described may implement a “hardware resource” mechanism based on a software framework that may provide control groups and namespaces over such hardware resources. Such a framework may provision: (a) an ability to add and partition hardware elements, for example, filed programmable gate array (FPGA), graphics processing unit (GPU), RAN compute, or AI, (b) an enforcement of usage limits and isolation for such a group of central processing unit (CPU) cores or other hardware resources which form processing element, and (c) an ability to define new custom “resources.”

In an embodiment, the hardware containerization framework may enable adding and partitioning hardware elements based on a custom resource definition (CRD) of the existing deployment framework. To enforce the usage limits and isolation for a group of CPU cores or other hardware resources, the framework may rely on the computing elements by extending the taxonomy of prevailing frameworks. Thus, such a framework, within the computing element, may be referred to as “hardware containers” that may enforce requirements to enable: 1) reserving a quantum of resources to a specific application, such that the sum of all the allocated hardware resources may not exceed the available hardware resources, 2) isolating the hardware resources such that execution of any operations using a set of hardware resources does not impact other sets of hardware resources, and 3) metering the utilized hardware resources by each application and optimize the utilization of available hardware resource pool.

With such a framework and the underlying provisioning from the hardware elements, hardware resources may be defined, provisioned, metered, isolated, and pooled. Accordingly, the proposed system and method may implement “virtualization” and “containerization” of hardware elements or resources. The ability to treat such hardware resources like compute resources may leverage all the benefits of containerization.

In an embodiment, the terms software components or components, software routines or routines, software models or models, software engines or engines, software scripts or scripts, and layers are used interchangeably throughout the subject specification unless context warrants distinction(s) amongst the terms based on implementation. The implementation primarily involves executing computer-readable code, such as a sequence of instructions, by a processor of a computing device (e.g., a special-purpose computer, a general-purpose computer, or a mobile device) in an integrated environment. The computing device may be configured to execute operations of the special-purpose computer when the instructions stored in the memory of the computing device are executed by the processor. The execution of specific operations enables the computing device to execute operations as the special purpose computer, thereby improving the technical operation of the special purpose computer. The execution of specific operations, individually or in cooperation, may collectively provide a platform, framework, or architecture that optimizes the allocation of computing resources. Such models, software components, and software routines may be reused based on definition and implementation.

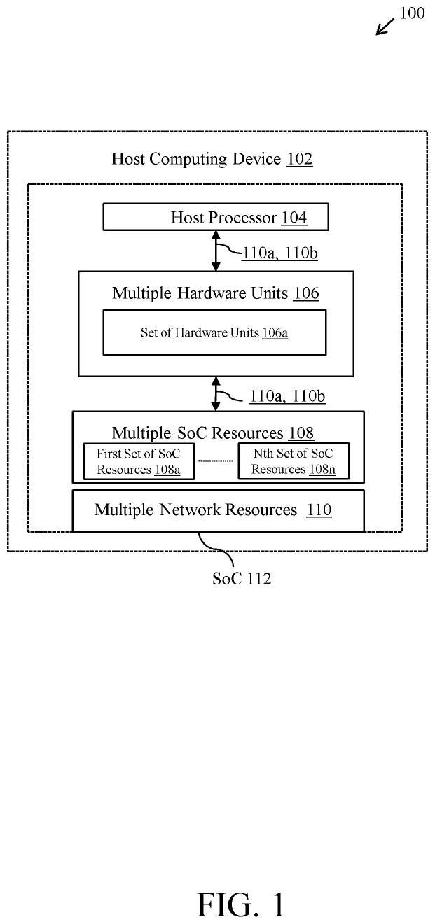

FIG. 1 is a block diagram showing a resource management system that implements components for managing a hardware containerization framework in a wireless network architecture, according to an exemplary embodiment. In an embodiment, a resource management system 100 for managing a hardware containerization framework is shown in FIG. 1. The hardware containerization framework may be implemented in a wireless network architecture, for example, that may include a digital signal processing (DSP)-based system, a radio access network (RAN), or a cloud computing environment.

In an embodiment, the resource management system 100 may embody the on-demand availability of compute, storage, or network resources in large data centers that house many computer nodes connected by internal networks. The resource management system 100 may execute operations to enable the availability of resources, for example, computer nodes, without direct active management by users who may be remotely connected via the Internet. The resource management system 100 may have functions, hardware, and other resources distributed across multiple locations. For example, distinct processing capabilities are available, such as general-purpose processors, special-purpose processors, and hardware accelerators.

In an embodiment, the resource management system 100 may be implemented in a cloud management system, such as OpenStack and Kubernetes, enabling embedding information directly within standalone application executable packages. The resource management system 100 may have embedded information in the execution packages to specify an execution context required for running an application, for example, by embedding deployment information within the standalone application executable package. The resource management system 100 may enable a selection of optimal accelerators for allocation for each accelerated application.

In another embodiment, the resource management system 100 may be implemented in a wireless system, wherein a wireless application, such as Hi-PHY processing, is required in Open-RAN (O-RAN) implementation. In such an implementation, a server farm used in such O-RAN implementation may use commercial-off-the-shelf (COTS) CPUs and accelerators, such as Lookaside forward error correction (FEC) accelerators or Inline Hi-PHY accelerators. A combination of a multi-core CPU with Peripheral Component Interconnect Express (PCIe) accelerator cards may manage the processing for multiple O-RAN processing chains, with each chain consuming a fraction of the compute resources. The specific number may depend on the deployment configuration. For example, a 100 Mhz 16DL/8UL configuration may have more computational capabilities than a 20 Mhz 4DL/4UL.

It should be noted that the above exemplary systems are merely for understanding purposes and should not be construed as limiting the scope of the disclosure.

Referring to FIG. 1, the resource management system 100 may include a host computing device 102 with a heterogeneous multiprocessor (or multi-core) architecture comprising multiple processing elements (PEs) of distinct types. A multi-core computing device may include a single integrated circuit that may include multiple core processing units or cores. Different multi-core processor architectures may vary in terms of the number of cores, number of core types (such as homogenous or heterogenous cores), number and level of caches, interconnection of cores, isolation (such as spatial or temporal isolation), and the like.

As shown in FIG. 1, the host computing device 102 may include a host processor 104 that may correspond to a PE associated with a general-purpose processor. The host computing device 102 may include multiple hardware units 106 (comprising at least a set of hardware units 106a) that may be PEs corresponding to domain-specific CPUs, such as DSPs, GPUs, AI, and RAN units. In an embodiment, the domain-specific (such as a DSP CPU subsystem) may include instrumentation modules related to monitoring resource usage. The instrumentation modules may not be configurable or programmable by the monitored resource (for example, DSP, GPUs, AI, RAN units, etc. For example, the bus interface used to program the Telemetry modules in an implementation may differ from the bus used for runtime data transfer by SW or IP modules. The objective is that the monitored resource cannot influence the measurement or actions related to containerization. In an embodiment, a resource identifier (ID) may associate a measurement with a specific hardware container.

The host computing device 102 may include multiple SoC resources 108, such as a first set of SoC resources 108a, . . . , and the Nth set of SoC resources 108n, which may be PEs corresponding to custom hardware resources. The host computing device 102 may include multiple network resources 110, such as an off-chip PCIe bus 110a and an on-chip Advanced extensible Interface (AXI) bus 110b. All such PEs, i.e., the host processor 104, the multiple hardware units 106, and the plurality of SoC resources 108 may be implemented in a system-on-a-chip (SoC) 112 of the host computing device 102. In an embodiment, the SoC 112 implementation may be independent and outside a server environment. The information related to the multiple hardware units 106 may be available as a table of hardware resources in the SoC as a part of a boot image. For example, accelerator cards may be plugged into the server via the PCIe interconnect.

In an embodiment, the host computing device 102 may correspond to a complex and heterogeneous platform with general-purpose processors, i.e., the host processor 104 may be coupled with the multiple hardware units 106 that may be massively parallel many-core accelerator fabrics (for example, embedded GPUs) implemented on the SoC 112. Examples of the host computing device 102 may include the Hypercore Architecture Line (HAL) multi-core processing system, a single-chip cloud computer, an RISC-V-based system, and the like.

The host processor 104 may include suitable logic, circuitry, and interfaces that may be configured to execute operations that may be a part of an application besides a running operating system. An execution flow starts from the host processor 104, and when a parallel program region is encountered, then the parallel program or a specific part of the parallel program may be offloaded to the multiple hardware units 106, such as accelerators, to gain benefit from its high performance. Since multiple hardware units 106 may not initialize the procedures in a parallel kernel, which is essential before starting the execution, the host processor 104 is configured to prepare the required execution environment (for example, I/O buffers allocation and initialization, parallel function pointer) before offloading the parallel kernel to the multiple hardware units 106. The offloading procedure is normally an asynchronous call-in to enable the host processor 104 to continue its execution in parallel with the multiple hardware units 106.

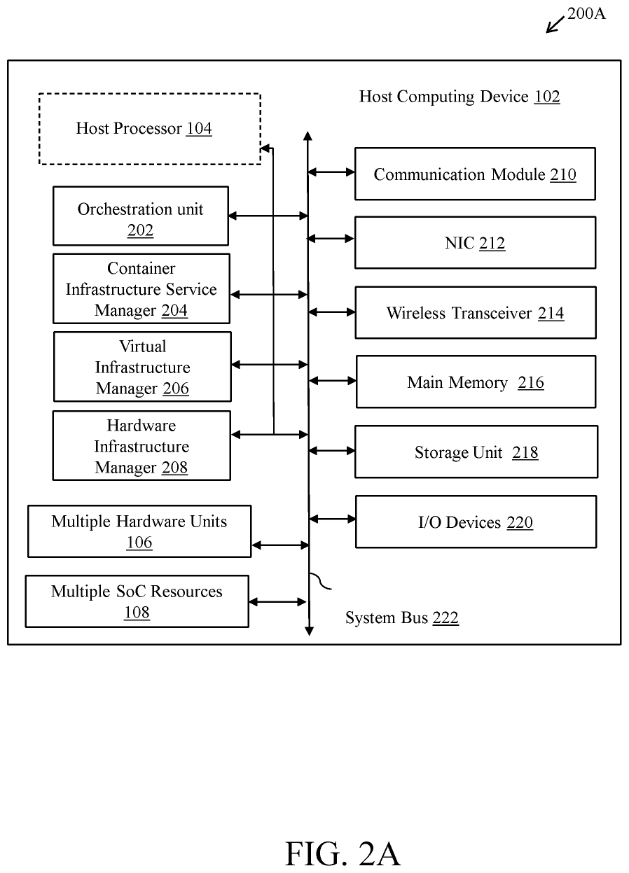

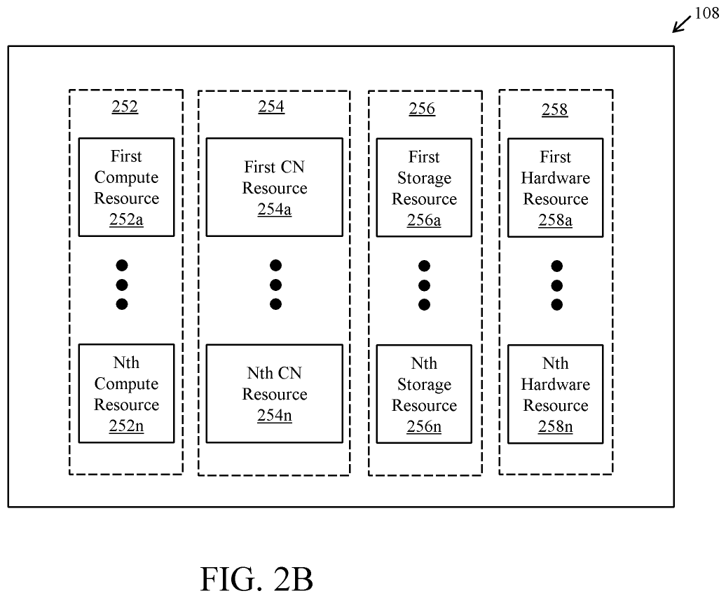

In an embodiment, the host processor 104 may be configured to orchestrate the multiple SoC resources 108 and/or the multiple network resources 110 in the resource management system 100. The host processor 104 may be configured to function as an orchestrator of the resource management system 100 by utilizing optimal hardware units from the multiple hardware units 106 at run time. Further, the orchestrator of the resource management system 100 may execute operations for managing a hardware containerization framework in a wireless network architecture. In an embodiment, the host processor 104 may store data to be processed in an external memory, such as the main memory 216 (as described in FIG. 2A), which may be connected to FPGA fabric via a DDR3 interface and the AXI bus 110b.

The host processor 104 may include a heterogenous multi-core processor, for example, multiple CPUs, microprocessors, general-purpose and/or specialized controllers, or some other processor array, that may perform computations and determine an executable operation of the host computing device 102 based on executable instructions stored in a main memory unit (such as main memory 216, as shown in FIG. 2) or commands provided by a user. It should be noted that the terms “server processor” or “microprocessor” include not only a traditional microprocessor (such as Intel's® industry-leading x86 and x64 architectures) but also graphics processors, matrix processors, a CISC, a RISC, ASIC, FPGA, microcontroller, DSP, programmable logic device, programmable logic array (PLA), microcode, instruction set, emulated or virtual machine processor, or any similar device, a combination of devices, or logic elements (hardware or software) that permit the execution of instructions.

The multiple hardware units 106 may be specialized computer hardware, which may include suitable logic, circuitry, and interfaces that may be specialized in executing highly parallel and computation-intensive parts of the application programs. The multiple hardware units 106 may correspond to purpose-built designs or co-processors accompanying the host processor 104 for accelerating a specific function or workload. Thus, the multiple hardware units 106 may execute operations to perform some functions more efficiently than those performed by or on general-purpose hardware processing components, such as CPUs. The multiple hardware units 106 may improve the power, performance, and area (PPA metric) of a processor-based system, i.e., the host computing device 102, independent of semiconductor process scaling. DSP functions like video codecs, communications error corrections, and filtering, AI learning and inferencing algorithms, optimized allocation of computing resources in a virtualized radio access network (vRAN), edge computing platform deployment (e.g., using FPGA), and the like are numerous examples of functions, in terms of PPA, when implemented as hardware accelerators.

In an embodiment, the multiple hardware units 106 may include application-specific integrated circuits (ASICs) and similar hardware components. An ASIC is designed or configured to compute a specific set of operations more efficiently than a general-purpose processor that executes the set of operations in software. Other types of the plurality of hardware units 106 may include GPUs, functions implemented on field programmable gate arrays (FPGAs), and similar specialized hardware components or combinations thereof.

The multiple hardware units 106 that may be embodied as accelerators from different vendors may have significant differences in hardware architecture, programming models, and middleware support. However, modern programming and execution frameworks for the multiple hardware units 106 may enable hardware accelerated applications to use distinct types and variants of accelerators for executing their specialized implementations. Such frameworks enable the deployment and execution of the same accelerated function source code across different accelerator devices, such as GPUs and FPGAs.

The multiple hardware units 106 may be referred to as kernel IPs (following the OpenCL terminology) that may be connected to the host processor 104 by the multiple network resources 110, such as the off-chip PCIe bus 110a and the AXI bus 110b. The off-chip PCIe bus 110a may correspond to an interface standard for connecting high-speed input-output (HSIO) components to the host processor 104. The on-chip AXI bus 110b may correspond to an interconnect specification for connection and management of functional blocks in designs of the SoC 112 that supports all advanced features, such as separate address and data phases, burst control, pipelined transfers with variable latency, and the like. The multiple hardware units 106 may be initially configured based on a bit stream downloaded by the host processor 104 via the infrastructure intellectual property (IP).

The multiple SoC resources 108 may include multiple sets of SoC resources, such as a first set of SoC resources 108a, . . . , and the Nth set of SoC resources 108n, that may collaborate to achieve a computational task. Each of the multiple sets of SoC resources may include a CPU with associated storage (volatile and non-volatile) and network resources that may be embodied as a processing element. In an exemplary scenario, a processing element, for example, the first set of SoC resources 108a, may correspond to a register-transfer level (RTL) implementation of a specialized data or control path flow. In such a scenario, RTL involves the specification of a digital circuit in terms of the flow of digital signals between hardware registers and the logical operations performed on such signals.

The multiple network resources 110 may include networking devices communicatively interconnected to other electronic devices on the network (for example, other network devices and end-user devices). In an embodiment, the multiple network resources 110 provide support for multiple networking functions, for example, routing, bridging, switching, aggregation, session border control, Quality of Service, subscriber management, and/or provide support for multiple application services, for example, data, voice, and video.

The SoC 112 may correspond to an integrated circuit (IC) that integrates components of a computer, including a CPU package, such as the multiple SoC resources 108 or other electronic systems, into a single chip. The SoC 112 may contain digital, analog, mixed-signal, and radio frequency functions, which may be provided on a single chip substrate. Other embodiments may include a multi-chip-module (MCM), with multiple chips located in a single electronic package and configured to interact closely with each other through the electronic package. It should be noted that all or parts of the hardware components of the system disclosed herein may readily be provided in the SoC 112, in the host computing device 102.

The SoC 112 may include different memory components at various levels of memory hierarchy and input/output (I/O) components, communicatively coupled or interconnected to each other via the multiple network resources 110, such as on-chip interconnect, buses, and the like. The PEs may also be referred to as modules on the SoC 112 that are typically semiconductor IP cores schematizing various computer system functions and designed to be modular. Between such modules on the SoC 112, a router-based packet switching network may be implemented, referred to as a network-on-a-chip (not shown).

In operation, one or more of the multiple hardware units 106 in the SoC 112 may be configured to transmit capability information to a host processor 104 in the host computing device 102. The capability information of each hardware unit of the multiple hardware units 106 may include a list of controllable hardware allocation parameters. The hardware allocation parameters may correspond to, for example, partitioning interface bandwidth and sharing a buffer pool of memory space between multiple processing flows. The hardware allocation parameters may further correspond to, for example, arbitration priorities, rate, and limiting of accesses to Double Data Rate (DDR) interface port allocation parameters for bus bandwidth allocation. The hardware allocation parameters may further correspond to, for example, static allocation (at deployment time) or auto-tuning (at run-time) of processing cycles of specialized DSP CPUs or accelerators. The capability information of each hardware unit of the multiple hardware units 106 may include a list of types of statistics and parameters associated with collecting statistical data, for example, periodicity.

Based on the capability information, the host processor 104 in the host computing device 102 may be configured to select the set of hardware units 106a from the multiple hardware units 106. The set of hardware units 106a selected from the multiple hardware units 106 may receive configuration information from the host processor 104. The configuration information may include selecting the one or more hardware allocation parameters and one or more types of statistics for one or more processing flows. Based on the received configuration information, the set of hardware units 106a may configure a hardware container to enable SoC resource allocation via multiple hardware modules in the SoC 112. The SoC resource allocation may be related to a control group and a namespace of multiple SoC resources 108. In an embodiment, the namespace of multiple SoC resources 108 may be identified by resource identifier (ID). The resource ID may identify the functional and instrumentation modules related to the hardware container.

The set of hardware units 106a may be further configured to manage the hardware container to enable periodic collection and analysis of the statistical data via multiple instrumentation modules in the SoC 112. The host processor 104 may track the impact of each processing flow based on the periodic collection and analysis of the statistical data by the selected set of hardware units 106a at run-time.

In an embodiment, the host processor 104 may transmit re-configuration information to the selected set of hardware units 106a at the run-time based on the tracked impact of each processing flow. The re-configuration information may correspond to either allocation or statistical data of the multiple SoC resources 108 during runtime. Based on the received re-configuration information from the host processor 104, the selected set of hardware units 106a from the multiple hardware units 106 may re-configure the hardware container to enable SoC resource allocation via a plurality of hardware modules in the SoC 112. The SoC resource allocation may be related to a re-configured control group and a re-configured namespace of the multiple SoC resources 108.

It should be noted that different embodiments and components of the resource management system 100 may execute corresponding operations or functions that various cloud resources may partially or fully implement as an integrated or distributed platform.

FIG. 2A shows an exemplary host computing device 102 for managing a hardware containerization framework in a wireless network architecture, according to an exemplary embodiment. A schematic representation 200A of the host computing device 102 in FIG. 2A may include various components, such as an orchestration unit 202, a container infrastructure service manager 204, a virtual infrastructure manager 206, a hardware infrastructure manager 208 (the preceding components are included in the host processor 104), a communication module 210, a network interface controller (NIC) 212, a wireless transceiver 214, a main memory 216, a storage unit 218, I/O devices 220, and a system bus 222.

In an embodiment, the host computing device 102 may manage a hardware container by selectively allocating and/or deallocating a set of hardware resources from the multiple SoC resources 108 as a function of Quality of Service (QOS) targets associated with a service level agreement for a workload associated with an application. Non-limiting examples of the QoS targets may include a target throughput, a target latency, a target number of instructions per second, and the like. In an embodiment, the host computing device 102 may determine whether one or more hardware resources may be deallocated from a processing unit while still meeting the requirements of QOS targets, thereby freeing up those hardware resources for use in another managed node (e.g., to execute a different workload).

In another embodiment, when the QoS targets are not presently meeting the requirements, the host computing device 102 may determine to dynamically allocate additional hardware resources to enable the execution of the workload associated with the application. In another embodiment, the host computing device 102 may determine dynamic deallocation of the hardware resources from a managed node when the host computing device 102 determines that deallocating the hardware resource would enable QoS parameters to be met.

The orchestration unit 202 may include suitable logic, circuitry, and interfaces that may execute operations to: (a) provision a hardware resource pool with the assistance of corresponding controllers; (b) handle optimizations of a selected set of hardware units 106a and available hardware resources; and (c) operate on one or several infrastructure resources, such as cloud infrastructures resources, RAN infrastructure resources, and the like, to meet the workload requirements according to service level agreements (SLA) that do not specify all implementation and resource details.

In an embodiment, the orchestration unit 202 may be configured to orchestrate multiple hardware infrastructure resources through containers or virtual machines in the resource management system 100. Containers and virtual machines may correspond to implementations that make applications independent from infrastructure resources. More specifically, a container may be a contained, deployable unit of software code package containing an application's code, corresponding libraries, and other dependencies. Containerization makes the applications portable, so the same code may run on any device. On the other hand, a virtual machine may be a digital copy of a physical machine. Multiple virtual machines may be realized with corresponding individual operating systems running on the same host operating system.

In an embodiment, the orchestration unit 202 may be further configured to manage the overall coordination of the applications in the resource management system 100. The applications may be assigned to the multiple SoC resources 108. Thus, the orchestration unit 202 at the host computing device 102 handles the central coordination, application subscriptions, and optimization of targets. The orchestration unit 202 may receive the locally collected configuration and analytics information from all workload agents in the resource management system 100. As a result, if a given application is deployed multiple times in the resource management system 100, the orchestration unit 202 may also provide historical analytics information to support workload management decisions in the workload agents. In an embodiment, the CPU used to manage the containerization mechanism may differ from the one controlling runtime operations. The various hardware resources related to containerization are accessible to this CPU through special paths. The software that may be deployed or configured for execution on this CPU takes decisions related to hardware containerization and performs programming actions. The software deployed may not share resources, such as memory, etc., with other runtime or application CPUs in the system. In an embodiment, the resource usage information is periodically gathered by the orchestration unit 202 and may be used to make decisions related to hardware containerization.

In an embodiment, a workload agent may execute operations as a local coordinator at a SoC resource that collects analytics information and issues control commands (according to load and monitoring information) to the clients embedded inside an application. In an embodiment, hypertext transfer protocol (HTTP) representational state transfer (REST) may be used for communication between a workload manager in the host computing device 102 and the workload agent embedded inside an application.

The orchestration unit 202 may provide service configuration and provisioning for the various workload agents. The orchestration unit 202 may collect data from the various workload agents and create a unified view. For example, when one processing node has one GPU and another processing node has one FPGA, the workload agents may collect partial analytics information. The orchestration unit 202 may store data for both the GPU and the FPGA and enable comparing the performance of each of these hardware units.

In an embodiment, the orchestration unit 202 may include an application programming interface (API), a resource manager, and a database. The API may include suitable logic, circuitry, and interfaces that may configure or provide access to the orchestration unit 202. The resource manager may include suitable logic, circuitry, and interfaces that may be configured to plan and schedule the right resource configuration, select the appropriate platform configuration, and deploy the workload in the resource management system 100. The database may be configured to store parameters, settings, data, or other information. The database may facilitate a knowledge database that may include various data indicating network topology information, which may be used to determine the placement of tasks and utilization of resources in the resource management system 100.

In an embodiment, the container infrastructure service manager 204 may include suitable logic, circuitry, and interfaces that may be configured to provide infrastructure resource management and lifecycle management of the execution environment for one or more container clusters in the resource management system 100. The container infrastructure service manager 204 may further manage one or more container infrastructure services. The container infrastructure service manager 204 may send the commands to container infrastructure service instances for creating and releasing containers. The container infrastructure service manager 204 may use Create, Read, Update, and Delete (CRUD) commands for the container resource management in the resource management system 100.

In an embodiment, the virtual infrastructure manager 206 may include suitable logic, circuitry, and interfaces that may be configured to manage virtual resources and make management capabilities accessible via one or more APIs. The virtual infrastructure manager 206 may be configured to manage logical constructs, such as tenants, tenant workloads, resource catalogs, identities, access controls, security policies, and the like. For example, the virtual infrastructure manager 206 may (a) set, manage, and delete tenants; (b) set, manage, and delete user accounts and service accounts; (c) manage access privileges; and (d) provision, manage, monitor, and delete virtual resources.

In an embodiment, the hardware infrastructure manager 208 may include suitable logic, circuitry, and interfaces that may be configured to manage abstracted hardware resources so that it is shielded from direct involvement with server host software. The hardware infrastructure manager 208 may be further configured to: (a) support equipment management for all managed physical hardware resources in the resource management system 100; (b) provision, manage, monitor, and delete hardware resources; (c) manage physical hardware resource discovery, monitoring, and topology, and (d) manage hardware infrastructure telemetry and log collection services in the resource management system 100.

In an embodiment, the communication module 210 may include routines for handling communication between the host computing device 102 and other resource management system 100 components. In some embodiments, the communication module 210 may include a set of instructions executable by the host processor 104 to provide the functionality for handling communications between the host computing device 102 and other resource management system 100 components.

In an embodiment, the communication module 210 may send and receive digital data and messages to and from one or more elements, such as the host processor 104, the multiple SoC resources 108, the multiple network resources 110, and other components of the resource management system 100. In an embodiment, such received data and messages may be stored in the storage unit 218 of the host computing device 102. In an embodiment, the communication module 210 may be stored in the main memory 216 of the host computing device 102 and may be accessible and executable by the host processor 104.

The NIC 212 may execute operations to transmit and receive data to and from the various components of the host computing device 102 within the resource management system 100. In an embodiment, the NIC 212 may include a port for direct physical connection to the host computing device 102 various components or other communication channels. For example, the NIC 212 may include a USB, SD, CAT-5, or similar port for wired communication with the various components of the host computing device 102. The NIC 212 may facilitate wired communication by providing an Ethernet connection or other types of networks, such as Controller Area Network (CAN), Local Interconnect Network (LIN), and the like.

The wireless transceiver 214 (or multiple transceivers) may correspond to a communication device that may communicate at different ranges using multiple standards or radios for communication. For example, in one scenario, an edge computing node may communicate with close devices, e.g., within about 10 meters, using a local transceiver based on Bluetooth Low Energy (BLE) or another low-power radio to save power. In another scenario, distant connected edge devices, e.g., within about 50 meters, may be reached over ZigBee® or other intermediate power radios. Both communication techniques may take place over a single radio at different power levels or over separate transceivers, for example, a local transceiver using BLE and a separate mesh transceiver using ZigBee®. In another scenario, devices or services within a network environment embodying the resource management system 100 may be reached via local or wide-area network protocols. The wireless transceiver 214 may be a low-power wide-area (LPWA) transceiver that follows the IEEE 802.15.4 or IEEE 802.15.4g standards, among others. The techniques described herein are not limited in scope and may be used with any number of other cloud transceivers that implement long-range, low-bandwidth communications, such as Sigfox and other technologies. Further, other communications techniques may be used, such as time-slotted channel hopping, described in the IEEE 802.15.4e specification.

In another embodiment, the wireless transceiver 214 may include a cellular communications transceiver that uses spread spectrum (SPA/SAS) communications to implement high-speed communications for sending and receiving data over a cellular communications network. Further, various protocols, such as Wi-Fi® networks for medium-speed communications and provision of network communications, may be facilitated by the wireless transceiver 214. The wireless transceiver 214 may include radios that are compatible with any number of 3GPP (Third Generation Partnership Project) specifications, such as Long Term Evolution (LTE) and 5th Generation (5G) communication systems and beyond.

The main memory 216 stores instructions and/or data that may be accessed by one or more processors, such as the host processor 104. The instructions and/or data may include code which, when executed by the one or more processors, the one or more processors may be configured to perform the techniques and method steps described herein. The main memory 216 may be, for example, a dynamic random-access memory (DRAM) device, a static random-access memory (SRAM) device, flash memory, or some other memory device. A portion of the main memory 216 may be reserved as a buffer or virtual random-access memory (virtual RAM).

The storage unit 218 may include a non-volatile memory or similar permanent storage device and media, including a hard disk drive, a CD-ROM device, a DVD-ROM device, a DVD-RAM device, a DVD-RW device, a flash memory device, or some other mass storage device for storing information, instructions and/or data on a more permanent basis.

The I/O devices 220 may include suitable logic, circuitry, and interfaces that may be configured to receive one or more user inputs and provide an output. The I/O devices 220 include various input and output devices based on which a user or another device may communicate with the host computing device 102. Examples of the I/O devices 220 may include, but are not limited to, a touch screen, a keyboard, a mouse, a joystick, a microphone, a display device, and a speaker.

The system bus 222 may facilitate various components of the host computing device 102 to communicate with each other. The system bus 222 may include one or more technologies, including industry standard architecture (ISA), extended ISA (EISA), peripheral component interconnect (PCI), PCI express (PCIe), peripheral component interconnect extended (PCIx), and the like. The system bus 222 may be a proprietary bus, for example, used in an SoC-based system. Other bus systems, such as an Inter-Integrated Circuit (I2C) interface, a Serial Peripheral Interface (SPI) interface, point-to-point interfaces, a power bus, and the like, may be included.

In different embodiments, different components of the host computing device 102 may execute corresponding operations or functionalities partially or fully implemented by various infrastructure resources as an integrated or distributed platform. In an embodiment, the plurality of individual processing engines may be implemented on a single device, such as the host computing device 102, as shown in the schematic representation 200A of FIG. 2A. In another embodiment, the plurality of individual processing engines may be distributed on more than one device as independent entities providing functionalities for which the individual distributed processing engines have been programmed. In such embodiment, communication between the individual distributed processing engines may be implemented through function calls managed by a distributed message exchange platform (not shown). The plurality of distributed processing engines may be used in parallel or sequentially within the resource management system 100 to create synergies with each other.

FIG. 2B shows exemplary sets of SoC resources for provisioning a hardware containerization framework in a wireless network architecture, according to exemplary embodiments. A schematic representation 200B of the multiple SoC resources 108 shows the multiple SoC resources 108 that may include multiple compute resources 252, such as a first compute resource 252a, . . . , Nth compute resource 252n, multiple communication and network (CN) resources 254, such as a first CN resource 254a, . . . , Nth CN resource 254n, a multiple storage resources 256, such as a first storage resource 256a, . . . , Nth storage resource 256n, and multiple hardware resources 258, such as a first hardware resource 258a, . . . , Nth hardware resource 258n.

The multiple compute resources 252, the multiple CN resources 254, the multiple storage resources 256, and the multiple hardware resources 258 may constitute the physical hardware layer of the host computing device 102 and serve as the foundation of various wireless infrastructures, for example, cloud infrastructure. Such physical hardware layer may be exposed to and used by a set of networked host operating systems in a cluster that normally handles a virtual infrastructure layer offering virtual machines and/or containers where the application workloads, i.e., virtual network functions (VNFs) and/or cloud-native network functions (CNFs), run.

The multiple compute resources 252 in the host computing device 102 may correspond to hardware elements in which code runs on the general purpose processing components (for example, CPUs), and one or more functions may be offloaded to accelerator devices, such as the multiple hardware units 106. In an embodiment, a compute resource may be a hardware unit that may execute certain instructions using associated resources, such as memory, network devices, and the like. In an embodiment, the multiple compute resources 252 may represent virtualized compute for workloads and other systems, as necessary. It may be noted that the multiple compute resources 252 may be in any infrastructure, such as a mobile network infrastructure, and similar or related infrastructure, such as edge cloud computing. Such infrastructure may be highly heterogeneous due to different CPU, GPU, DSP, and FPGA models from different third-party vendors.

Each of the multiple CN resources 254 may include communication resources that may be configured to facilitate data communications between various components of the host computing device 102 within the resource management system 100. The multiple CN resources 254 may be configured to utilize a variety of different protocols and data communication fabrics to facilitate data communications between such components. For example, the multiple CN resources 254 may include fiber channel (‘FC’) technologies, such as FC fabrics and FC protocols, which may transport SCSI commands over FC networks. The multiple CN resources 254 may include FC over ethernet (‘FCOE’) technologies through which FC frames are encapsulated and transmitted over Ethernet networks. The multiple CN resources 254 may also include InfiniBand (‘IB’) technologies, in which a switched fabric topology may facilitate transmissions between channel adapters. The multiple CN resources 254 may also include non-volatile memory Express (‘NVMe’) technologies and NVMe over fabrics (‘NVMeoF’) technologies through which non-volatile storage media attached via a PCI express (‘PCIe’) bus may be accessed. The multiple CN resources 254 may also include mechanisms for accessing the multiple storage resources 256 utilizing serial attached SCSI (‘SAS’), serial ATA (‘SATA’) bus interfaces, internet small computer systems interface (‘iSCSI’) technologies, and other communications resources that may be useful in facilitating data communications between various components within the resource management system 100.

The multiple CN resources 254 may also include network resources that may be configured to transfer data within a specific infrastructure. The multiple CN resources 254 may include locations representing the named location of a network, servers, routers, switches, load balancers, and other network equipment that may provide layer 2 and layer 3 connectivity and internet protocol (IP) address pools. The multiple CN resources 254 may be organized by pods, network containers, and network zones.

Each of the multiple storage resources 256 may store persistent data in many forms. In some embodiments, the multiple storage resources 256 may include 3D cross-point non-volatile memory or another nonvolatile random access memory. In other embodiments, the multiple storage resources 256 may include flash memory, including single-level cell (‘SLC’) NAND flash, multi-level cell (‘MLC’) NAND flash, triple-level cell (‘TLC’) NAND flash, quad-level cell (‘QLC’) NAND flash, and the like. In other embodiments, the multiple storage resources 256 may include nano-RAM, non-volatile magnetoresistive random-access memory (‘MRAM’), including spin transfer torque (‘STT’) MRAM, non-volatile phase-change memory (‘PCM’), quantum memory, resistive random-access memory (‘ReRAM’), storage class memory (‘SCM’). It should be noted that other forms of computer memory and storage devices may be utilized by the storage systems described above, including DRAM, SRAM, EEPROM, universal memory, and the like.

The multiple hardware resources 258 may include a set of hardware elements that can perform a computational task in its capacity or when used in conjunction with other hardware elements. For example, the multiple hardware resources 258 may include instrumentation and hardware modules in the IP core of the SoC 112. The multiple hardware resources 258 may further define new custom resources by a designer at will. In an embodiment, the hardware resources 258 may be on-chip.

Referring to FIG. 2B, each of the multiple SoC resources 108 may include resources from the multiple compute resources 252, the multiple CN resources 254, the multiple storage resources 256, and the multiple network resources 110. For example, the first set of SoC resources 108a may include the first compute resource 252a, the first CN resource 254a, the first storage resource 256a, and the first hardware resource 258a. Similarly, the Nth set of SoC resources 108n may include the Nth compute resource 252n, the Nth CN resource 254n, the Nth storage resource 256n, and an Nth hardware resource 258n.

It is to be noted that the above configuration is just for understanding purposes and should not be construed to be limiting the scope of the disclosure. For example, a set of SoC resources may include more than one instance of resources from one or more of the multiple compute resources 252, the multiple CN resources 254, the multiple storage resources 256, and the multiple hardware resources 258 in any combinational pattern.

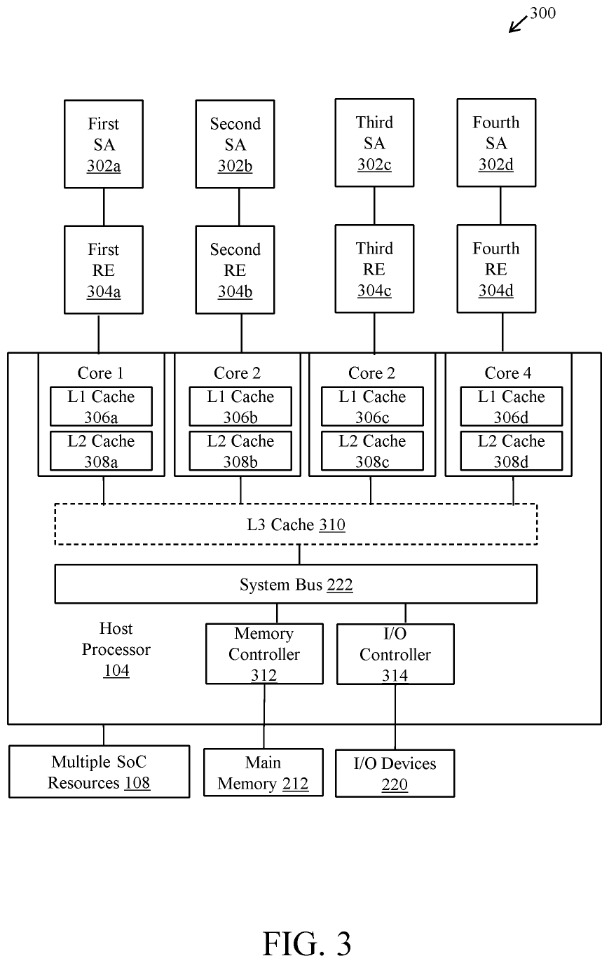

FIG. 3 shows a block diagram of an exemplary heterogenous multi-core host processor for managing a hardware containerization framework in a wireless network architecture, according to an exemplary embodiment. FIG. 3 is described in conjunction with FIG. 2A and FIG. 1. FIG. 3 shows a block diagram 300 of an exemplary heterogenous multi-core host processor corresponding to the host processor 104 hereinafter. In an embodiment, the block diagram 300 may include multiple software applications, such as a first software application (SA) 302a, a second SA 302b, a third SA 302c, and a fourth SA 302d, that may be allocated to different operating systems, such as a first runtime environment (RE) 304a, a second RE 304b, a third RE 304c, and a fourth RE 304d, respectively.

Such different operating systems may be allocated to different cores in the heterogeneous multi-core processor. For example, the first OS 304a, the second OS 304b, the third OS 304c, and the fourth OS 304d, may be allocated to Core 1, Core 2, Core 3, and Core 4, respectively. In various exemplary scenarios, such as multiple cores, i.e., Core 1, Core 2, Core 3, and Core 4, maybe a combination of different CPU cores, for example, a CPU core, a GPU core, a DSP core, an AI core, a RAN core, and the like. Such multiple cores may vary in terms of the number of cores, asymmetric or symmetric core types, number and level of instruction and data caches, interconnection of cores, and isolation in terms of physical and spatial isolation.

Referring to FIG. 3, there are shown three levels of cache, which are progressively larger but slower: L1, which consists of an instruction cache and a data cache; L2, and L3. Note that the L1 and L2 caches are local to different specific cores, whereas L3 is shared among all the cores. In general, an L1 cache is a cache memory directly built into a processor and stored in a CPU's recently accessed information. Further, an L2 cache is a memory located outside and separated from the CPU chip core, although found on the same CPU chip package. Further, an L3 cache is a cache memory used by the CPU and is usually built onto the motherboard within the CPU module.

As shown in FIG. 3, L1 cache 306a and L2 cache 308a are local to Core 1, L1 cache 306b and L2 cache 308b are local to Core 2, L1 cache 306c and L2 cache 308c are local to Core 3, and L1 cache 306d and L2 cache 308d are local to Core 4. L3 cache 310 may be shared by all the cores, i.e., Core 1, Core 2, Core 3, and Core 4. L3 cache 310 may be connected to a system bus 222. The system bus 222 may be further connected to various controllers, such as memory controller 312 and an I/O controller 314. The main memory 216 and the I/O devices 220 may be controlled by the memory controller 312 and the I/O controller 314, respectively.

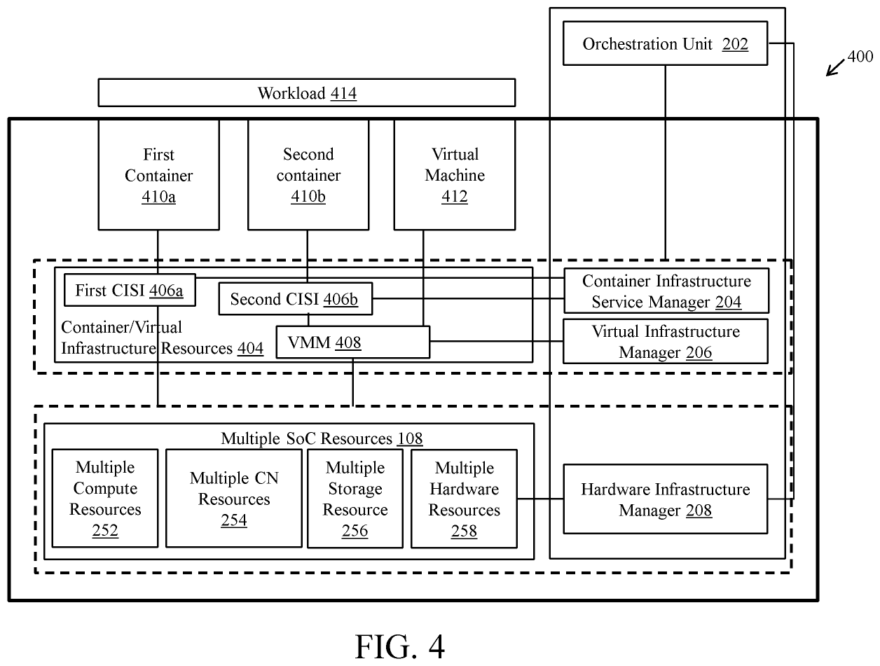

FIG. 4 shows an exemplary infrastructure for managing a hardware containerization framework in a wireless network architecture, according to an exemplary embodiment. FIG. 4 is described in conjunction with FIG. 2A. With reference to FIG. 4, there is shown a cloud infrastructure 400, which may include container/virtual infrastructure resources 404, which may further include a first container infrastructure service instance (CISI) 406a, a second CISI 406b, and a virtual machine manager (VMM) 408. The cloud infrastructure 400 may include a first container 410a, a second container 410b, a virtual machine 412, and application workload 414. Additional components may include the orchestration unit 202, the container infrastructure service manager 204, the virtual infrastructure manager 206, and the hardware infrastructure manager 208. 2A.

The multiple SoC resources 108 may represent a hardware resource pool that may include physical hardware components such as servers (e.g., random access memory, local storage, network ports, and hardware acceleration devices), storage devices, network devices, and the basic input output system (BIOS). As shown in FIG. 4, the multiple SoC resources 108 may include the multiple compute resources 252, the multiple CN resources 254, the multiple storage resources 256, and the multiple hardware resources 258 that serve as a hardware layer for the foundation of the cloud infrastructure 400. The hardware layer is exposed to and used by a set of networked host operating systems in a cluster that normally handles the virtual infrastructure layer offering virtual machines and/or containers where the application workload 414, for example, virtual network functions (VNFs)/cloud-native network functions (CNFs) are executed.

The container/virtual infrastructure resources 404 may correspond to all the instances of the containers, such as the first CISI 406a and the second CISI 406b, and VMs, such as the VMM 408, that may be managed by tenants and tenant workloads directly or indirectly via an application programming interface (API).

The first CISI 406a and the second CISI 406b may correspond to instances providing runtime execution and hosting environment for a plurality of containers, such as the first container 410a and the second container 410b.

The VMM 408 may provision or facilitate the execution of various functionalities, such as (a) setting up, managing, and deleting tenants, (b) setting up, managing, and deleting user accounts and service accounts, (c) managing access privileges, and (d) provisioning, managing, monitoring and deleting virtual resources, such as the VM 412.

The first container 410a and the second container 410b may correspond to hardware containers configured to isolate the execution of hardware elements or resources and custom workloads, such as AI, GPU, RAN, and the like. For example, operations and dependent functions or processing of the L1 High-PHY may be executed in the L1 High-PHY container. Similarly, the operations and dependent functions or processing of the L2 MAC may be executed in the L2 MAC container.

The VM 412 may correspond to a virtual instance of the multiple SoC resources 108 that presents an abstract computing platform.

The application workload 414 may correspond to virtualized and/or containerized network functions that run within a set of containers, such as the first container 410a and the second container 410b, or a VM, such as the VM 412.

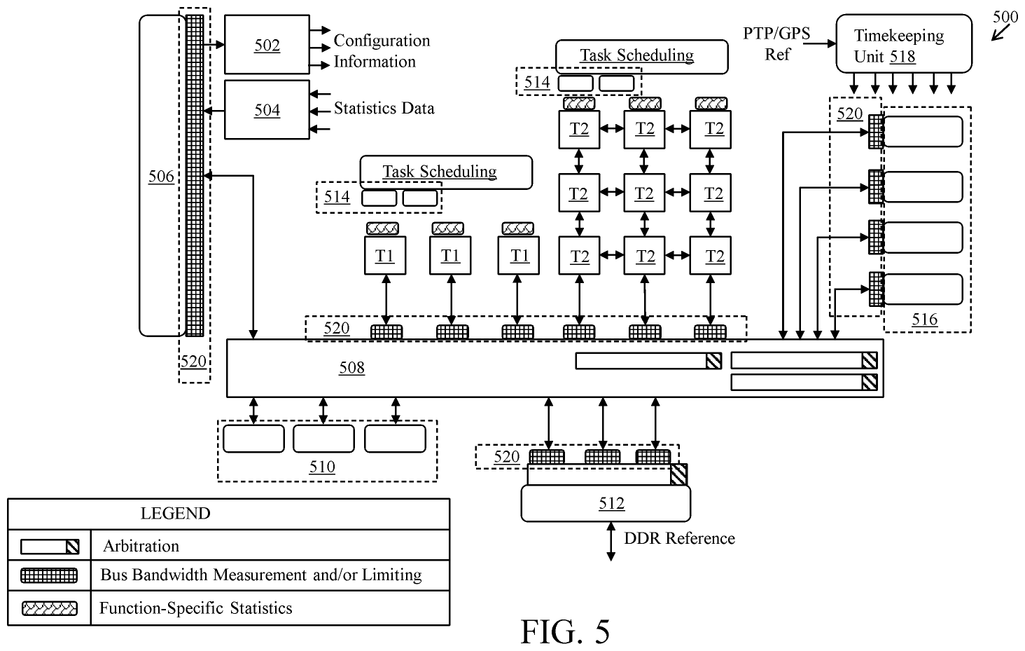

FIG. 5 shows a block diagram of the hardware architecture, resource allocation, and statistical data collection schema of a wireless accelerator SoC 500, according to an exemplary embodiment. FIG. 5 is described in conjunction with FIG. 1, FIG. 2A and FIG. 2B. In an embodiment, FIG. 5 shows a wireless accelerator SoC 500 that includes a resource management entity 502, a statistics management entity 504, a PCIe 506, an Interconnect 508, SRAM banks 510, a memory controller 512, counters 514, Ethernet 516, a timekeeping unit 518, and instrumentation modules 520.

The resource management entity 502 may include suitable logic, circuitry, and/or interfaces that may be configured to: (a) create hardware containers, such as the first container 410a and the second container 410b, (b) allocate the multiple SoC resources 108 for the creation of the hardware containers, (c) manage control groups, and (d) monitor statistics requirements.

The resource management entity 502 may execute operations to process such information and, in turn, generate actions within the wireless accelerator SoC 500. For example, the operations may include configuring the various hardware and software components that help to manage the multiple SoC resources 108 for various containers, i.e., the first container 410a and the second container 410b, and collecting statistics in the desired manner. The resource management entity 502 may further manage allocation and management actions related to control groups.

In an embodiment, the resource management entity 502 may manage the SoC resource allocation for distinct categories of operations or functions in different ways. For example, the wireless accelerator SoC 500 may have multiple instances of specialized domain-specific functions that may implement controls that are specific to the function. The wireless accelerator SoC 500 may have a task scheduling function to distribute tasks among different tiles, shown as ‘T1’ and ‘T2’, that perform specialized functions. Processing cycles of such tiles may realize the multiple compute resources 252 (e.g., as shown in FIG. 2B). The multiple hardware resources 258 (e.g., as shown in FIG. 2B) may implement specialized assists or counters to optimize them. The multiple hardware resources 258 (e.g., as shown in FIG. 2B) may include bandwidth-limiting modules inserted in specific points to manage the bus traffic. The multiple storage resources 256 (e.g., as shown in FIG. 2B) may include memory management functions that constrain the usage of memory spaces (physical or virtual) for a given processor/processor tile/processing cluster. The multiple CN resources 254 (e.g., as shown in FIG. 2B) may include an interconnect that may include various programmable policies to partition bandwidth between different flows. Any violation of these constraints may generate an exception. The multiple CN resources 254 (e.g., as shown in FIG. 2B) may further include bus bandwidth that may be allocated, and isolation may be enforced for some interconnect arbitration steps that enable Master-Source accesses between the different ports. Any violation of pre-programmed path constraints may lead to exceptions. Specific actions that may be required to enforce the usage limits may vary depending on function and implementation.

The statistics management entity 504 may include suitable logic, circuitry, and/or interfaces that may be configured to collect various statistical data from multiple instrumentation modules 520 within the wireless accelerator SoC 500 for sending to the overall orchestration function, i.e., the orchestration unit 202 (e.g., as shown in FIG. 2A). To achieve the same, the statistics management entity 504 may need to manage queues, direct memory accesses (DMAs), and the like. The wireless accelerator SoC 500 may be required to support logic to collect the statistical data that balances flexibility, area/power, and support for various functions. Software controllability may be required to adapt to different deployments, and the ability to select specific measurements based on need. The statistics management entity 504 may collect measurements for sharing with the orchestration unit 202 (e.g., as shown in FIG. 2A).

The PCIe 506 may support multiple physical links combined into a single logical link for increased bandwidth, thereby providing optimal solutions for a variety of applications, from high-end graphic cards to low-end network adapters. The PCIe 506 may provide advanced system diagnostics, error recovery, power management, and traffic differentiation.

The Interconnect 508 may be a front-end RTL IP that provides a connection between processors and coherence controllers, PEs, last-level system caches, and DRAM memories.

The SRAM banks 510, or static random access memory banks, may correspond to a type of semiconductor memory that stores data using a latching or flip-flop circuitry to store each bit. If the wireless accelerator SoC 500 has a cache hierarchy, SRAM banks 510 may be used for cache.

The memory controller 512 is a digital circuit that manages data flow to and from the wireless accelerator SoC 500. The memory controller 512 may be a separate chip or integrated into another chip, such as on the same die, i.e., the SoC 112, or as an integral part of the microprocessor, i.e., the set of hardware units 106a.

Each of the counters 514, the instrumentation modules 520, and the timekeeping unit 518, collectively referred to as statistics collection probes, may include suitable logic, circuitry, and/or interfaces that may be configured to be inserted at various points in the wireless accelerator SoC 500 to gather different sorts of statistical data. Special counters, such as counters 514, may capture runtime information, such as CPU cycle counts, in the set of hardware units 106a. The instrumentation modules 520 may measure bus bandwidth at different points in the architecture of the set of hardware units 106a. The timekeeping unit 518 is required in case the set of hardware units 106a is implemented in a radio IC in which send/receive operations are typically linked to some global reference, such as Global Positioning System (GPS) or Precision Time Protocol (PTP) time. The protocol elements in a radio IC usually demonstrate periodicity. For example, a frame structure, as defined by 5G-NR, repeats periodically. As a result, the internal operations inside the wireless accelerator SoC 500 may also demonstrate periodic behavior. In such embodiment, the timekeeping unit 518 may correlate measurements with the external reference time for the periodic behavior. In an embodiment, multiple processing chains may share the hardware resources of the same wireless accelerator SoC 500. Each chain may operate at a different relative delay with respect to the external reference. The timekeeping unit 518 may capture timestamps for the different statistics, enabling an external processing software to derive the overall peak usage conditions for the wireless accelerator SoC 500. The statistics collection probes may also include measurement circuits associated with specialized functions (“Tiles”), shown as ‘T1’ and ‘T2’.

The collected statistical data may be shared with statistics management entity 504 and the orchestration unit 202 (e.g., as shown in FIG. 2A). In an embodiment, the information collected by statistics collection probes may be transmitted to the statistics management entity 504. The statistics management entity 504 may convert the information to a form suitable for sharing with the orchestration unit 202 (e.g., as shown in FIG. 2A). Thus, hardware support in the form of DMAs, bus interface modules, queue managers, and the like may be involved in managing the transfers.

The Ethernet 516, as known in the art, may correspond to an external interface of the hardware unit in the wireless accelerator SoC 500 that defers as per the intended application. Apart from the Ethernet 516, other examples of external interfaces based on communication protocols may include WiFi, USB, I2C, SPI, HDMI, and the like.

In an embodiment, support for various checks and exceptions may be built into the various SoC resources of the wireless accelerator SoC 500. In certain cases, for each flow, counters 514 may be maintained to count the events for which exceptions or interruptions may be triggered when the cycle count exceeds predefined pre-programmed limits. In other cases, instrumentation modules 520 for bus bandwidth measurement and/or limiting may be attached to the interconnect 508 to snoop for violations of allowable address spaces by specific bus masters.

It should be noted that the level of support provided by any device for the types of features listed above may be product and implementation dependent.

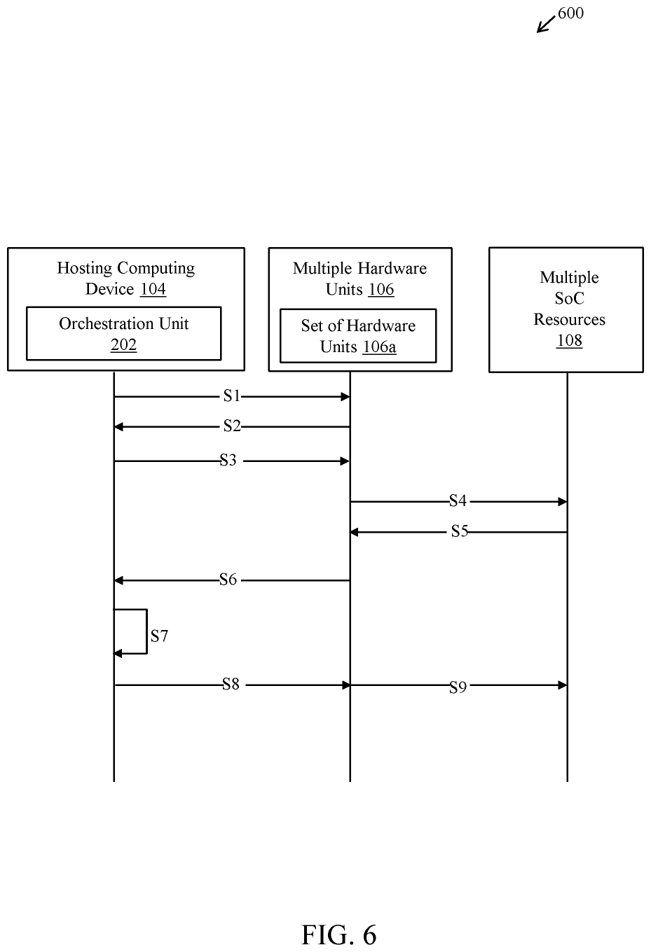

FIG. 6 shows a sequence diagram 600 depicting a sequence of operational steps corresponding to various SoC components for managing a hardware containerization framework in a wireless network architecture, according to exemplary an embodiment. FIG. 6 is described in conjunction with FIG. 1 and FIG. 2A. The sequence diagram 600 includes the orchestration unit 202 in the host computing device 102, the plurality of hardware units 106, and the multiple SoC resources 108 in the SoC 112, collectively depicting a sequence of operational steps for managing a hardware containerization framework in a wireless network architecture. The sequence of operational steps may be performed in two phases. The first phase may correspond to an initial capability exchange phase after power-up, and the second phase may correspond to a runtime operation phase. The initial capability exchange phase may occur between the host processor 104 and resource and statistics management entities and the plurality of hardware units 106 immediately on the power-up.

At S1, each hardware unit from the multiple hardware units 106 in the SoC 112 may transmit corresponding capability information to the host processor 104. The capability information may include multiple controllable hardware allocation parameters corresponding to the multiple SoC resources 108. The capability details may include multiple types of statistics and parameters associated with the collection of statistical data, such as periodicity and the like.

At S2, the host processor 104 may select the set of hardware units 106a from the multiple hardware units 106 based on the capability information. The host processor 104 may decide which set of hardware units 106a is to be selected from the multiple hardware units 106 and how to configure such a selected set of hardware units 106a.

At S3, the host processor 104 may perform actual configuration steps for the selected set of hardware units 106a. In other words, the host processor 104 may transmit configuration information to the selected set of hardware units 106a. The configuration information may include selecting one or more hardware allocation parameters and one or more types of statistics for one or more processing flows.

At S4, based on the received configuration information from the host processor 104, the selected set of hardware units 106a from the multiple hardware units 106 may configure a hardware container, such as the first container 410a or the second container 410b, to enable SoC resource allocation related to a control group and a namespace of the multiple SoC resources 108 via a plurality of hardware modules in the SoC 112. The resource and statistics management entities in the selected set of hardware units 106a may perform allocation configuration in IPs and/or buses and instrumentation configuration in various instrumentation modules, such as the instrumentation modules 520 and the hardware modules, such as the multiple hardware resources 258, in IPs to enforce allocation of the multiple SoC resources 108 to generate multiple hardware containers, i.e., the first container 410a and/or the second container 410b.

At S5, the multiple SoC resources 108 corresponding to the generated hardware containers, i.e., the first container 410a and/or the second container 410b, may transmit statistical data periodically to the selected set of hardware units 106a.

At S6, the counters 514 and the instrumentation modules 520 in the selected set of hardware units 106a may transmit the periodically collected statistical data to the orchestration unit 202 in the host processor 104.

At S7, based on the periodic collection and analysis of the statistical data received from the counters 514 and the instrumentation modules 520, the orchestration unit 202 in the host processor 104 may manage the hardware container, i.e., the first container 410a and/or the second container 410b. For example, the orchestration unit 202 may track the impact of each processing flow in the hardware container, i.e., the first container 410a and/or the second container 410b.

At S8, the orchestration unit 202 may transmit re-configuration information to the selected set of hardware units 106a at run-time based on the tracked impact of each processing flow. The re-configuration information may correspond to either allocation or statistical data of the multiple SoC resources 108 during runtime.

At S9, based on the received re-configuration information from the host processor 104, the selected set of hardware units 106a from the multiple hardware units 106 may re-configure the hardware container, i.e., the first container 410a and/or the second container 410b, to enable SoC resource allocation related to a re-configured control group and a re-configured namespace of the multiple SoC resources 108 via multiple hardware modules in the SoC 112.

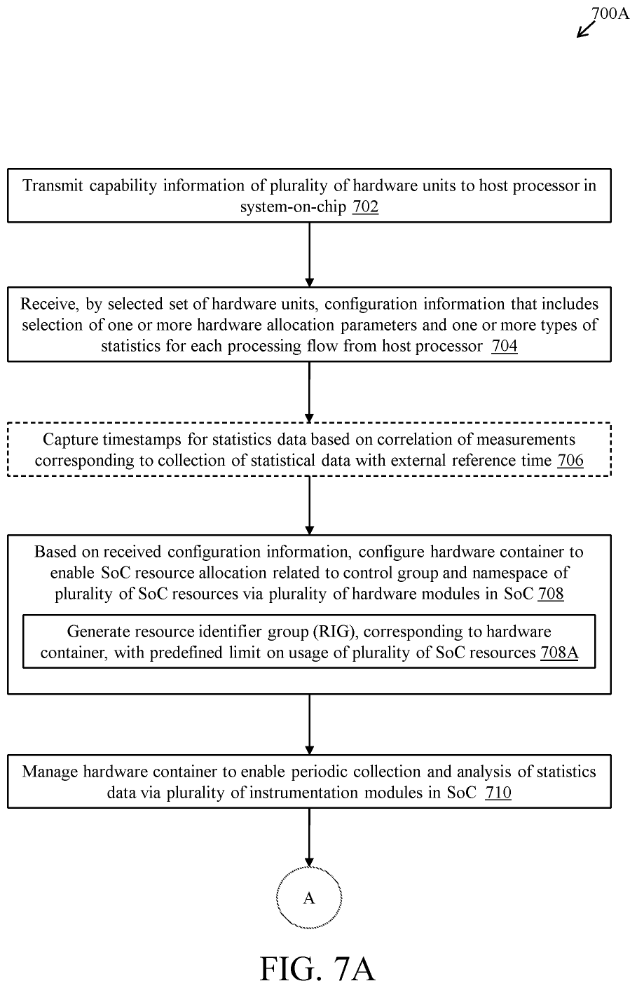

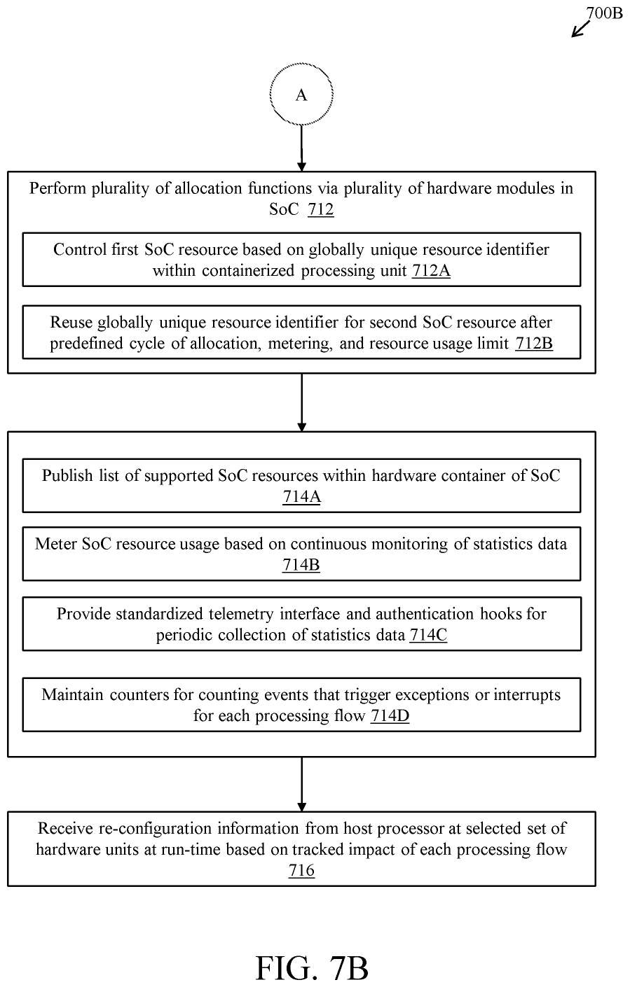

FIGS. 7A and 7B show flowcharts 700A and 700B collectively depicting a mechanism that includes operational steps for managing a hardware containerization framework in a wireless network architecture, according to an exemplary embodiment. FIGS. 7A and 7B are described in conjunction with FIGS. 1 to 6.

It should be noted that the method, sequence, and/or algorithm described in connection with the embodiments disclosed herein may be embodied directly in firmware, hardware, in a software module executed by the plurality of hardware units 106, or in a combination thereof. A software module may reside in a local or integrated memory unit, such as RAM, flash memory, ROM memory, EPROM memory, EEPROM memory, registers, hard disk, physical and/or virtual disk, a removable disk, a CD-ROM, virtualized system, or device such as a virtual servers or container, or any other form of storage medium known in the art.

At 702, capability information of the multiple hardware units 106 may be transmitted to the host processor 104 in the SoC 112. In an embodiment, the multiple hardware units 106 may be configured to transmit capability information of the multiple hardware units 106 to the host processor 104 in the SoC 112. In an embodiment, the capability information of each hardware unit may include a list of controllable hardware allocation parameters and a list of types of statistics and parameters associated with the collection of statistical data.

In an embodiment, the set of hardware units 106a may be selected from the plurality of hardware units 106 by the host processor 104 based on the capability information. Examples of the plurality of hardware units 106 may correspond to at least one of a generic FPGA, GPU, RAN, AI, and the like.

At 704, configuration information that includes the selection of one or more hardware allocation parameters and one or more types of statistics for each processing flow may be received from the host processor 104. In an embodiment, the set of hardware units 106a may be configured to receive configuration information that includes the selection of one or more hardware allocation parameters and one or more types of statistics for each processing flow from the host processor 104.

At 706, timestamps may be captured for the statistical data based on the correlation of measurements corresponding to a collection of statistical data with external reference time. In an embodiment, the set of hardware units 106a may be configured to capture timestamps for the statistical data based on the correlation of measurements corresponding to a collection of statistical data with external reference time.

It should be noted that step 706, which corresponds to timekeeping, will be performed during the collection of statistical data in Radio ICs. The send/receive operations of a Radio installation may be linked to a global reference, such as GPS or PTP time. The protocol elements of the Radio demonstrate periodicity. For example, the frame structure, as defined by 5G-NR, repeats periodically. Accordingly, the internal operations inside the SoC resource also demonstrate periodic behavior. Therefore, a mechanism to correlate measurements with the external reference time is required to understand the periodic behavior. In an embodiment, multiple processing chains may share the resources of the same SoC 112. Each chain may be operating at a different relative delay with respect to the external reference. In such embodiment, based on the captured timestamps for the different statistical data, the set of hardware units 106a may be configured to derive overall peak usage conditions for the multiple SoC resources 108.

At 708, based on the received configuration information, at least one hardware container, such as the first container 410a or the second container 410b, may be configured to enable SoC resource allocation related to the control group and namespace of the plurality of SoC resources 108 via a plurality of hardware modules in the SoC 112. In an embodiment, the set of hardware units 106a may configure, based on the received configuration information, at least one hardware container, such as the first container 410a or the second container 410b, to enable SoC resource allocation related to the control group and namespace of the multiple SoC resources 108 via a plurality of hardware modules in the SoC 112.

In an embodiment, the SoC resource allocation may correspond to allocating and monitoring various resource types. For example, in the case of a Wireless Accelerator SoC for each processing flow being executed therein, the resource types may be (a) processing cycles of specialized DSP, CPUs, or Accelerators, (b) Memory space—both internal SRAM and external DDR, (c) Bus bandwidth—both internal interconnect and external DDR, and (d) Interface bandwidth—relevant for PCIe, Ethernet and the like. The load or requirements imposed by each resource type may be composed of two kinds of components. The first component may be a fixed load, such as a Fast Fourier Transform (FFT) operation that must be performed on an Orthogonal Frequency-division Multiplexing (OFDM) symbol. The second component may be a variable load, for example, the processing overhead arising from each user protocol data unit (PDU) passing through the processing chain, or the number of iterations of an FEC Decoder.

It should be noted that the variable component may not be completely estimated at allocation time. Thus, the allocation needs to be done based on some assumptions, and regular monitoring is needed to ensure that the actual usage does not exceed the estimated total. Various SoC functions may work together to achieve the objectives described above. In an embodiment, the SoC resource allocation may correspond to at least one of the processing cycles of one or more processors or the plurality of hardware units 106, memory space, bus bandwidth, and interface bandwidth in the SoC 112. The management for each resource type in the SoC 112, such as wireless accelerator SoC 500 (as shown in FIG. 5), is described hereinafter in Table 1.

TABLE 1
Resource Management in SoC 112

| Component | Allocation | Monitoring | SoC Feature |
|---|---|---|---|
| Processing cycles of | Allocated statically | Need to be | Counters to |
| specialized DSP | at deployment time | monitored per flow | measure resource |
| CPUs or Hardware | but may need to be | for comparison | usage per Hi-PHY. |
| units (i.e., | tuned at runtime. | against initial static | Counters to enable |
| Accelerators) | Proportion of time | allocation. | runtime scheduling |
| | allocated for SoC | | decisions, although |
| | resources among | | final control is more |
| | different flows may | | likely to be in |
| | need runtime | | software. |
| | adjustment through | | |
| | software control. | | |
| Memory space | Mostly statically | Need to compare | Counters to |
| | allocated by | actual vs. estimate if | monitor per-Hi-PHY |
| | management of | shared memory | buffer usage in case |
| | buffer pointers. | buffers are used. | of shared buffer |
| | However, in some | | pools. |
| | cases, the same pool | | |
| | of buffers may be | | |
| | potentially shared | | |
| | between different | | |
| | processing flows. | | |
| Bus bandwidth | Exact allocation is | Support statistics | Programmable |
| | not possible in such | counters are needed | arbitration priorities. |
| | cases. | to monitor bus usage | Rate limiting |
| | Mechanisms, such as | for a specific | controls for bus |
| | arbitration priorities | processing flow. | interfaces. |
| | and rate limiting of | | Rate measurements |
| | access DDR | | for bus accesses. |
| | interface port | | |
| | allocation | | |
| | parameters, must be | | |
| | tweaked. | | |
| Interface Bandwidth | Interface bandwidth | Need to support | Counters to |
| | may be partitioned | statistics counters to | measure traffic per |
| | between multiple | measure bandwidth | processing flow. |
| | processing flows | consumption per | Programmable |
| | using mechanisms | processing flow. | arbitration policies. |
| | such as bus | | |
| | arbitration policies. | | |

In an embodiment, one hardware container may be isolated from another resource or a group of resources in the IP of the SoC 112. For example, the first container 410a may be isolated from the second container 410b in the IP of the SoC 112.

In an embodiment, the SoC resource allocation may be enabled differently for different categories of domain-specific functions of processor tiles in the SoC 112. In an exemplary scenario, the wireless accelerator SoC 500 may have a task scheduling function for distributing tasks among different tiles, shown as ‘T1’ and ‘T2’ in FIG. 5, that perform specialized functions.

In an embodiment, the multiple allocation functions may include adding hardware elements in the hardware container and partitioning the hardware elements. In such embodiments where partitioning of resources within a hardware element is provided, the framework for managing the hardware containers may further provide for it.
1. Definition and creation of a hardware resource and its corresponding twin of destroying this logical resource.
2. Creation and destruction of a hardware container.
3. Issuance of a quota of hardware resources to the hardware container.
4. Reservation, allocation, and binding the hardware resource or a group of hardware resources to a hardware container.
5. Metering the usage of hardware resources within a hardware container.
6. Isolation between the hardware containers and the hardware resources or a group of hardware resources.
7. Monitor and estimate the power consumption of the hardware container and resources.
8. Continuous monitoring and statistics gathering on hardware resource usage that enables potential machine learning applications for optimal usage of the hardware resource and optimal power consumption.
9. Authentication hooks for security.

For implementing one or more of the above, the framework needs the underlying managed hardware resource to publish and adhere to a set of guidelines and interfaces that support the same.

At 708A, a resource identifier group (RIG) corresponding to the hardware container, such as the first container 410a or the second container 410b, may be generated with a predefined limit on usage of the multiple SoC resources 108. In an embodiment, the set of hardware units 106a may be configured to generate the RIG corresponding to the hardware container, such as the first container 410a or the second container 410b, with a predefined limit on usage of the multiple SoC resources 108. In an embodiment, utilization of the multiple SoC resources 108 in the RIG may be enabled by a resource scheduler within the corresponding SoC resource.

At 710, the hardware container, such as the first container 410a or the second container 410b, may be managed based on a periodic collection and analysis of the statistical data via a plurality of instrumentation modules in the SoC 112. In an embodiment, the set of hardware units 106a may be configured to manage the hardware container, such as the first container 410a or the second container 410b, based on a periodic collection and analysis of the statistical data via a plurality of instrumentation modules, such as the instrumentation modules 520, in the SoC 112.

In an embodiment, based on the periodic collection and analysis of the statistical data by the selected set of hardware units 106a at run-time, the impact of each processing flow may be tracked at the host processor 104. In an embodiment, the impact of each processing flow tracked at the host processor 104 may be further based on the captured timestamps when the wireless infrastructure corresponds to a RAN infrastructure.

Referring now to FIG. 7B, at 712, a plurality of allocation functions may be performed via the plurality of hardware modules in SoC 112. In an embodiment, the set of hardware units 106a may be configured to perform a plurality of allocation functions via the plurality of hardware modules in SoC 112.

At 712A, a first SoC resource may be controlled based on a globally unique resource identifier within a processing element. In an embodiment, the set of hardware units 106a may be configured to control a first SoC resource based on a globally unique resource identifier within a processing element. In an embodiment, a resource identifier pool may be shared across the multiple compute resources 252.

At 712B, the globally unique resource identifier may be reused for a second SoC resource after predefined allocation cycles, metering, and resource usage limits. In an embodiment, the set of hardware units 106a may be configured to reuse the globally unique resource identifier for a second SoC resource after predefined allocation cycles, metering, and resource usage limits.

At 714A, a list of the multiple SoC resources 108 supported within the hardware container of SoC 112 may be published. In an embodiment, the set of hardware units 106a may be configured to publish the list of multiple SoC resources 108 supported within the hardware container of SoC 112.

At 714B, SoC resource usage may be metered based on continuous monitoring of the statistical data. In an embodiment, the set of hardware units 106a may be configured to meter SoC resource usage based on continuous monitoring of the statistical data.

At 714C, a standardized telemetry interface and authentication hooks may be provided for the periodic collection of the statistical data. In an embodiment, the set of hardware units 106a may be configured to provide a standardized telemetry interface and authentication hooks for the periodic collection of statistical data.

At 714D, counters 514 may be maintained for counting events that trigger exceptions or interrupts for each processing flow. In an embodiment, the set of hardware units 106a may be configured to maintain counters 514 for counting events that trigger exceptions or interrupts for each processing flow. In an embodiment, the exceptions or the interrupts may be triggered when the cycle count exceeds a pre-programmed threshold value.

At 716, re-configuration information may be received from the host processor 104 at the selected set of hardware units 106a at run-time based on the tracked impact of each processing flow. In an embodiment, the set of hardware units 106a may be configured to receive re-configuration information from the host processor 104 at the selected set of hardware units 106a at run-time based on the tracked impact of each processing flow.

In an embodiment, the re-configuration information may include at least one of the new hardware allocation parameters and new statistic types and parameters within the IP of the SoC 112.

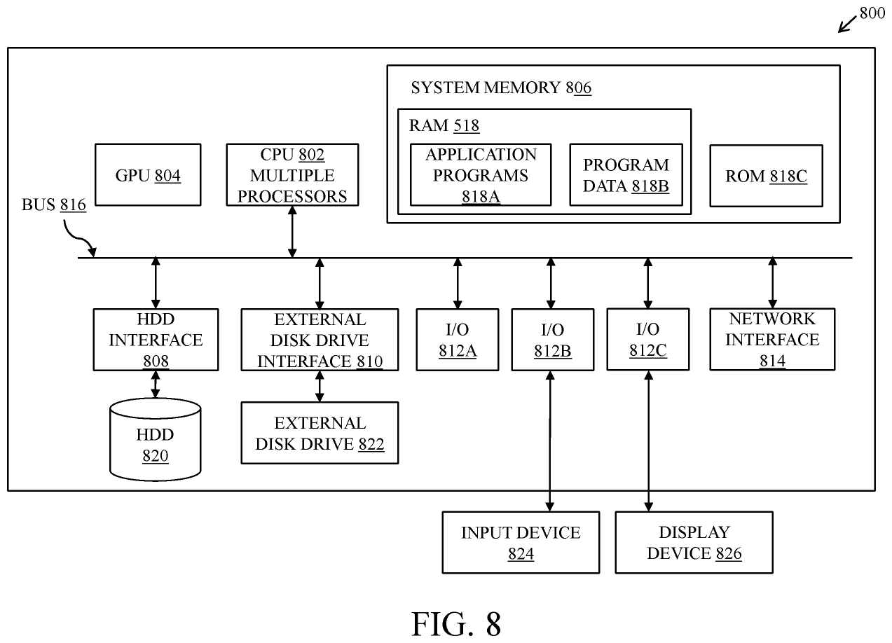

FIG. 8 shows an exemplary hardware configuration of a computing device 800 that may be used to implement components of a resource management system 100 for managing a hardware containerization framework in a wireless network architecture, according to an exemplary embodiment.

The computing device 800 shown in FIG. 8 includes a CPU 802, a GPU 804, a system memory 806, a hard disk drive (HDD) interface 808, an external disk drive interface 810, input/output (I/O) interfaces 812A, 812B, 812C, and a network interface 814. These elements of the computer are coupled to each other via a system bus 816.

The CPU 802 may perform arithmetic, logic, and/or control operations by accessing the system memory 806. The CPU 802 may implement the processors of the exemplary devices and/or systems described above.

The GPU 804 may perform operations for processing graphic or AI tasks. If the computing device 800 is used to implement an exemplary central processing device, GPU 804 may be GPU 804 of the exemplary central processing device as described above. The computing device 800 does not necessarily include GPU 804, for example, if the computing device 800 is used for implementing a device other than central processing.

The system memory 806 may store information and/or instructions for use in combination with the CPU 802. The system memory 806 may include volatile and non-volatile memory, such as random-access memory (RAM) 818 and read-only memory (ROM) 818C. A basic input/output system (BIOS) containing the basic routines that help to transfer information between elements in the computing device 800, such as during start-up, may be stored in ROM 818C. The system bus 816 may be any of several types of bus structures, including a memory bus or memory controller, a peripheral bus, and a local bus using any of a variety of bus architectures.

The computer may include the network interface 814 for communicating with other computers and/or devices via a network.

Further, the computer may include HDD 820 for reading from and writing to a hard disk (not shown) and external disk drive 822 for reading from or writing to a removable disk (not shown). The removable disk may be a magnetic disk for a magnetic disk drive or an optical disk such as a CD ROM for an optical disk drive. The HDD 820 and external disk drive 822 are connected to the system bus 816 by HDD interface 808 and external disk drive interface 810, respectively. The drives and their associated non-transitory computer-readable media provide non-volatile storage of computer-readable instructions, data structures, program modules, and other data for the general-purpose computer. The relevant data may be organized in a database, for example, a relational or object database.

Although the exemplary environment described herein employs a hard disk (not shown) and an external disk (not shown), it should be appreciated by those skilled in the art that other types of computer-readable media can store data that is accessible by a computer, such as magnetic cassettes, flash memory cards, digital video disks, random access memories, read-only memories, and the like, may also be used in the exemplary operating environment.

Several program modules may be stored on the hard disk, external disk, ROM 818C, or RAM 818, including an operating system (not shown), one or more application programs 818A, other program modules (not shown), and program data 818B. The application programs may include at least a part of the functionality as described above.

The computing device 800 may be connected to an input device 824, such as a mouse and/or keyboard, and a display device 826, such as a liquid crystal display, via corresponding I/O interfaces 812A to 812C and the system bus 816. In addition to an implementation using the computing device 800, as shown in FIG. 8, a part or all the functionality of the exemplary embodiments described herein may be implemented as one or more hardware circuits. Examples of such hardware circuits may include, for example, Large-scale integration (LSI), RISC, ASIC, and FPGA.

Various embodiments of the disclosure include a method for managing hardware containerization in a wireless network architecture. The method may include transmitting capability information of the plurality of hardware units 106 to the host processor 104 in the SoC 112. The capability information of each hardware unit may include a list of controllable hardware allocation parameters and a list of types of statistics and parameters associated with the collection of statistical data. The set of hardware units 106a may be selected from the plurality of hardware units 106 by the host processor 104 based on the capability information. The method may include receiving, by the selected set of hardware units 106a, configuration information that includes the selection of one or more hardware allocation parameters and one or more types of statistics for each processing flow from the host processor 104. Based on the received configuration information, the method may include configuring a hardware container to enable SoC resource allocation related to a control group and a namespace of the multiple SoC resources 108 via a plurality of hardware modules in the SoC 112. The method may further include managing the hardware container based on periodic collection and analysis of the statistical data via a plurality of instrumentation modules 520 in the SoC 112. Based on the periodic collection and analysis of the statistical data by the selected set of hardware units 106a at run-time, the impact of each processing flow is tracked at the host processor 104.

In an embodiment, the method may include receiving re-configuration information from the host processor 104 at the selected set of hardware units 106a at the run-time based on the tracked impact of each processing flow. The re-configuration information may include at least one of the new hardware allocation parameters and new statistic types and parameters within the IP of the SoC 112.

In an embodiment, the method may include capturing timestamps for the statistical data based on the correlation of measurements corresponding to the collection of the statistical data with an external reference time. The impact of each processing flow tracked at the host processor 104 may be further based on the captured timestamps. Based on the captured timestamps for the statistical data, the method may include deriving overall peak usage conditions for the multiple SoC resources 108.

In an embodiment, the method may include publishing a list of the multiple SoC resources 108 supported within the hardware container of the SoC 112. In an embodiment, the method may further include metering SoC resource usage based on continuous monitoring of the statistical data. In an embodiment, the method may include providing a standardized telemetry interface and authentication hooks for the periodic collection of statistical data. The hardware container may be isolated from other resources or a group of resources in the IP of the SoC 112.

In an embodiment, the method may further include, for each processing flow, maintaining counters for counting events that trigger exceptions or interrupts. The exceptions or the interrupts may be triggered when a cycle count exceeds a pre-programmed threshold value.

In an embodiment, SoC resource allocation is enabled differently for various categories of domain-specific functions of processor tiles in the SoC 112. The SoC resource allocation may correspond to at least one of the processing cycles of one or more processors or the plurality of hardware units 106, memory space, bus bandwidth, and interface bandwidth.

In an embodiment, the method may include performing a plurality of allocation functions via the plurality of hardware modules in the SoC 112. The plurality of allocation functions may include adding hardware elements in the hardware container and partitioning the hardware elements.

In an embodiment, the method may further include controlling a first SoC resource based on a globally unique resource identifier within a processing element. A resource identifier pool may be shared across a plurality of compute resources. In an embodiment, the method may include reusing the globally unique resource identifier for a second SoC resource after a predefined allocation cycle, metering, and resource usage limit.

In an embodiment, the method may include generating a resource identifier group (RIG) corresponding to the hardware container, with a predefined limit on usage of the multiple SoC resources 108. A resource scheduler within the corresponding processing element may enable the utilization of the multiple SoC resources 108 in the RIG.

Various embodiments of the disclosure further include a system for managing hardware containerization in a wireless network architecture. The system may comprise a memory, such as a system memory 806, for storing instructions and a processor, such as the CPU 802, in a first hardware unit configured to execute the instructions. Based on the executed instructions, the processor may be further configured to transmit capability information to the host processor 104 in the SoC 112. The capability information may be received from one or more second hardware units by the host processor 104. The capability information of each hardware unit may include a list of controllable hardware allocation parameters and a list of types of statistics and parameters associated with the collection of statistical data. The set of hardware units 106a, which includes at least the first hardware unit, may be selected from the plurality of hardware units 106 by the host processor 104 based on the capability information. The plurality of hardware units 106 may include the first hardware unit and one or more second hardware units. The processor may be further configured to receive configuration information that includes the selection of one or more hardware allocation parameters and one or more types of statistics for one or more processing flows from the host processor. Based on the received configuration information, the processor may be configured to configure a hardware container to enable SoC resource allocation related to a control group and a namespace of SoC resources via a plurality of hardware modules in the SoC 112. The processor may be further configured to manage the hardware container based on periodic collection and analysis of the statistical data via a plurality of instrumentation modules in the SoC 112. Based on the periodic collection and analysis of the statistical data by the selected set of hardware units 106a at run-time, an impact of each processing flow may be tracked at the host processor 104.

The proposed system and method for managing a hardware containerization framework in a wireless network architecture provide various advantages. In existing systems and methods, process containers or control groups are limited to resources, such as memory and generic control CPU compute, which can be scheduled by the operating system. Therefore, such software containers, manifested as process containers, only provide CaaS.

To overcome such challenges, the proposed system and method discloses virtualization and containerization of hardware resources for handling custom workloads, such as AI, GPU, and RAN, that define new resources like “RAN Compute” and others that need to be treated like resources. Accordingly, the mechanism of provisioning and metering is extended to non-CPU-like Processing Elements. In an embodiment, synchronizing measurement timestamps a reference, like PTP or GPS, to provide various advantages so that: a) the combined temporal effect of various flows working together in the system can be obtained and compared against expectations, and b) relative scheduling of the various flows can be optimized after the analysis, resulting in lower overall power consumption. In another embodiment, measurement of the resources consumed at a flow granularity can have the following advantages: improvement in overall usage of resources and optimization of power consumption by minimizing resource usage.

Those of skill in the art will appreciate that the various illustrative logical blocks, modules, processing engines, circuits, algorithms, and/or steps described in connection with the embodiments disclosed herein may be implemented as electronic hardware, computer software, firmware, or combinations thereof. To illustrate this interchangeability of hardware and software, various illustrative components, blocks, modules, engines, circuits, and steps have been described below generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

Further, many embodiments are described in terms of sequences of actions or steps to be performed by specific circuits (e.g., ASICs), program instructions being executed by one or more processors, or by a combination of both. Additionally, these sequences of actions described herein can be considered to be embodied entirely in any non-transitory form of computer-readable storage medium, having stored therein a corresponding set of instructions that, upon execution, would cause an associated processor to perform the functionality described herein. Thus, the various aspects of the disclosure may be embodied in a number of different forms, which have been contemplated to be in the scope of the claimed subject matter. In addition, for each of the embodiments described herein, the corresponding form of any such embodiments may be described herein as, for example, “logic configured to” perform the described action.

The present disclosure may also be embedded in a computer program product, which includes all the features enabling the implementation of the methods described herein and which, when loaded in a computer system, may implement these methods. A computer program in the present context means any expression, in any language, code, or notation, either statically or dynamically defined, of a set of instructions intended to cause a system having an information processing capability to perform a particular function either directly or after either or both of the following: a) conversion to another language, code, or notation; b) reproduction in a different material form.

While the present disclosure has been described with reference to certain embodiments, it will be noted understood by, for example, those skilled in the art that various changes and modifications could be made and equivalents may be substituted without departing from the scope of the present disclosure as defined, for example, in the appended claims. In addition, many modifications may be made to adapt a particular situation or material to the teachings of the present disclosure without departing from its scope. The functions, steps, and/or actions of the method claims in the embodiments of the disclosure described herein need not be performed in any order. Furthermore, although elements of the disclosure may be described or claimed in the singular, the plural is contemplated unless limitation to the singular is explicitly stated. Therefore, it is intended that the present disclosure is not limited to the embodiment disclosed but that the present disclosure will include all embodiments falling in the scope of the appended claims.

One or more embodiments are now described with reference to the drawings, wherein like reference numerals are used to refer to like elements throughout. In the following description, for purposes of explanation, numerous specific details are set forth to provide a thorough understanding of the various embodiments. It is evident, however, that the various embodiments can be practiced without these specific details (and without applying them to any networked environment or standard).

As used in this application, in some embodiments, the terms “component,” “system,” and the like are intended to refer to, or comprise, a computer-related entity or an entity related to an operational apparatus with one or more specific functionalities, wherein the entity can be either hardware, a combination of hardware and software, software, or software in execution. For example, a component may be, but is not limited to being, a process running on a processor, an object, an executable, a thread of execution, computer-executable instructions, a program, and/or a computer. By way of illustration and not limitation, both an application running on a server and the server can be a component.

The above descriptions and illustrations of embodiments, including what is described in the Abstract, are not intended to be exhaustive or to limit the one or more embodiments to the precise forms disclosed. While specific embodiments of, and examples for, the one or more embodiments are described herein for illustrative purposes, various equivalent modifications are possible in the scope, as those skilled in the relevant art will recognize. These modifications can be made considering the above-detailed description. Rather, the scope is to be determined by the following claims, which are to be interpreted in accordance with established doctrines of claim construction.

What is claimed is:

1. A method for managing hardware containerization in a wireless network architecture, comprising:
transmitting to a host processor, capability information of a plurality of hardware units in a system on chip (SoC),
wherein the capability information of each hardware unit from the one or more hardware units includes a plurality of controllable hardware allocation parameters and a plurality of types of statistics and parameters associated with collected statistical data, and
wherein a set of hardware units is selected from the plurality of hardware units by the host processor based on the capability information;
receiving, by the selected set of hardware units, configuration information that includes a selection of one or more hardware allocation parameters and one or more types of statistics associated with one or more processing flows from the host processor;
based on the received configuration information, configuring a hardware container to enable an SoC resource allocation related to a control group and a namespace of SoC resources via a plurality of hardware modules in the SoC; and
managing the hardware container based on a periodic collection and analysis of statistical data via a plurality of instrumentation modules in the SoC,
wherein, based on the periodic collection and analysis of the statistical data by the selected set of hardware units at run-time, an impact of the one or more processing flows tracked at the host processor.

2. The method of claim 1, further comprising: based on the tracked impact of the one or more processing flows, receiving re-configuration information from the host processor by the selected set of hardware units at run-time,
wherein the re-configuration information includes at least one of a new hardware allocation parameter and a new statistic type and parameters within an intellectual property (IP) of the SoC.

3. The method of claim 1, further comprising:
based on a correlation of measurements corresponding to the collection of the statistical data with an external reference time, capturing timestamps for the statistical data,
wherein the impact of the one or more processing flows is tracked at the host processor based on the captured timestamps; and
based on the captured timestamps for the statistical data, deriving overall peak usage conditions for the SoC resource.

4. The method of claim 1, further comprising: publishing a list of supported SoC resources within the hardware container of the SoC.

5. The method of claim 1, further comprising: metering the SoC resource usage based on continuous monitoring of the statistical data.

6. The method of claim 1, further comprising: providing a standardized telemetry interface and authentication hooks for the periodic collection of the statistical data.

7. The method of claim 1, wherein the hardware container is isolated from a group of resources in the SoC intellectual property (SIP).

8. The method of claim 1, further comprising: for the one or more processing flows, maintaining counters for counting events that trigger exceptions or interrupts,
wherein the exceptions or the interrupts are triggered when a cycle count exceeds a pre-programmed threshold value.

9. The method of claim 1, wherein the SoC resource allocation is enabled differently for different categories of domain-specific functions of processor tiles in the SoC,
wherein the SoC resource allocation corresponds to at least one of processing cycles of one or more processors or the plurality of hardware units, memory space, bus bandwidth, and interface bandwidth.

10. The method of claim 1, further comprising: performing a plurality of allocation functions via the plurality of hardware modules in the SoC, and
wherein the plurality of allocation functions includes adding hardware elements in the hardware container and partitioning the hardware elements.

11. The method of claim 1, further comprising: controlling a first SoC resource based on a globally unique resource identifier within a processing element,
wherein a resource identifier pool is shared across a plurality of compute resources.

12. The method of claim 1, further comprising: reusing a globally unique resource identifier for a second SoC resource after a predefined cycle of allocation, metering, and resource usage limit.

13. The method of claim 1, further comprising: generating a resource identifier group (RIG) associated with the hardware container, wherein the RIG includes a predefined limit on usage of the SoC resource.

14. The method of claim 1, wherein utilization of the SoC resource in the RIG is enabled by a resource scheduler within a corresponding processing element.

15. A system for managing hardware containerization in a wireless network architecture, comprising:
a memory for storing instructions; and
a processor in a first hardware unit configured to execute the instructions, causing the system to perform operations related to:
transmit capability information to a host processor in a system on chip (SoC),
wherein the capability information of each hardware unit includes a plurality of controllable hardware allocation parameters and a plurality of types of statistics and parameters associated with a collection of statistical data, and
wherein a set of hardware units, including at least a first hardware unit, is selected from a plurality of hardware units, which includes the first hardware unit and the one or more second hardware units, by the host processor based on the capability information;
receive configuration information that includes a selection of one or more hardware allocation parameters and one or more types of statistics for one or more processing flows from the host processor;
based on the received configuration information, configure a hardware container to enable an SoC resource allocation related to a control group and a namespace of SoC resources via a plurality of hardware modules in the SoC; and
manage the hardware container based on a periodic collection and analysis of the statistical data via a plurality of instrumentation modules in the SoC,
wherein, based on the periodic collection and analysis of the statistical data by the selected set of hardware units at run-time, an impact of the one or more processing flows is tracked at the host processor.

16. The system of claim 15, wherein the processor is further configured to perform operations related to: based on the tracked impact of each processing flow, receive re-configuration information from the host processor at run-time,
wherein the re-configuration information includes at least one of a new hardware allocation parameter and a new statistic type and parameters within an intellectual property (IP) of the SoC.

17. The system of claim 15, wherein the SoC resource allocation is enabled differently for different categories of domain-specific functions of processor tiles in the SoC,
wherein the SoC resource allocation corresponds to at least one of: processing cycles of one or more processors or the plurality of hardware units, memory space, bus bandwidth, and interface bandwidth.

18. The system of claim 15, wherein the processor is further configured to perform operations related to: perform a plurality of allocation functions via the plurality of hardware modules in the SoC, and
wherein the plurality of allocation functions includes adding hardware elements in the hardware container and partitioning the hardware elements.

19. The system of claim 15, wherein the processor is further configured to perform operations related to:
control a first SoC resource based on a globally unique resource identifier within a processing element,
wherein a resource identifier pool is shared across a plurality of compute resources and
reuse a globally unique resource identifier for a second SoC resource after a predefined cycle of allocation, metering, and resource usage limit.

20. The system of claim 15, wherein the processor is further configured to perform operations related to: generate a resource identifier group (RIG) associated with the hardware container, wherein the RIG includes a predefined limit on usage of the SoC resource,
wherein utilization of the SoC resource in the RIG is enabled by a resource scheduler within a corresponding processing element.
